(19) United States
(12) Patent Application Publication
(10) Pub. No.: US 2019/0332606 A1
(43) Pub. Date: Oct. 31, 2019

(54) A system and method for processing big data using electronic document and electronic file-based system that operates on RDBMS

(71) Applicants: KIM SENG KEE, Kuala Lumpur (MY); KEONG HWAY CHHUA, Kuala Lumpur (MY)

(72) Inventors: KIM SENG KEE, Kuala Lumpur (MY); KEONG HWAY CHHUA, Kuala Lumpur (MY)

(21) Appl. No.: 15/771,871

(22) PCT Filed: May 30, 2016
(86) PCT No.: PCT/MY16/50034

§ 371 Date: Apr. 27, 2018

(30) Foreign Application Priority Data
Oct. 30, 2015 (MY) PI 2015703925

(51) Int. Cl. G06F 16/25; G06F 16/2458; G06F 16/2457; G06F 16/23; G06F 16/18; G06F 16/93

(52) U.S. Cl. CPC G06F 16/254; G06F 16/252; G06F 16/2465; G06F 16/93; G06F 16/2358; G06F 16/1805; G06F 16/24573

(57) ABSTRACT

The proposed invention relates to a system to storing and processing a big data dataset that operates on relational database management system (RDBMS), comprising; a electronic document (11) having at least one electronic document identifier, section, rowtype and column extracted from the big data; a virtual memory for storing the relevant electronic document (11); a electronic form to capture data entry by at least one user based on set of instructions and pre-defined data field in at least one electronic dictionary; and a web-read module (4) for retrieving the electronic document (11) from the virtual memory using at least one identifier of electronic document (11) based on the data of electronic form, wherein the electronic document append into at least one electronic file in the RDBMS according to a predefined page limit by a paging module and at least one account number defined by the user in the electronic form.

### FIELD OF INVENTION

The proposed invention relates to a system and method for analyzing a Big Data dataset to emulate manual filing system by storing and processing document that operates on relational database. In particularly, using electronic document (eDoc) and electronic file (eFile) based system that operates on relational database.

### BACKGROUND ART

Big Data is large or complex data sets that traditional data processing applications such as Oracle, IBM's DB2 and Microsoft's SQL Server might not be able to process. The main challenge face by having such big data include complexity in performing analysis, capture, data curation, search, sharing, storage, transfer, visualization, and information privacy. Value from data is extracted through predictive analytics or other advanced methods. Accuracy in big data may lead to more confident decision making.

The existing system that uses relational database management system (RDBMS) as its relational database for big data will struggle when the record of data grows to billions or trillions in number and RDBMS will not be able to achieve real-time response. RDBMS solutions which are capable of handling such volumes are extremely expensive and not reliable. Furthermore, the big data also demands collection of an extremely wide variety of data types, but the existing RDBMSs have inflexible schemas to archive it.

Big data is accumulated at a very high velocity, therefore using RDBMSs for Big data is prohibitively expensive, as the existing RDBMSs are designed for steady data retention, rather than for rapid growth. Veracity in data analysis is the biggest challenge as there are biases, noise and abnormality in data. The originality of data is not maintained when it is stored in existing RDBMS, where the stored data is always distributed to tables.

Therefore an invention is proposed a system and method to store, to extract and to process big data using electronic document and electronic file-based system that operates on a relational database.

### SUMMARY OF INVENTION

One object of the invention is to reduced the RDBMS vertical stack size tremendously which also improved data retrieval speed, where instead of creating a new row for each record in relational database management system (RDBMS), the Account-centric electronic file technology encapsulates any many electronic document as possible before storing as a new record in RDBMS. For instance, data streaming in real-time from social media, Radio Frequency Identification (RFID) and so forth are feed directly into electronic file before storing in RDBMS.

Another object of the invention is a system for extracting data from electronic document by receiving instruction from a program having a electronic form and to retrieve a list of account using the retrieving means. Thereafter, the system verifies if the list contains any unprocessed account and retrieves electronic document using the retrieving means, if there is unprocessed account for extracting fields of electronic document. Finally, populating the extracted data into output table and return the table as result.

The present invention provides a system to storing and processing a big data dataset that operates on relational database management system (RDBMS), comprising; a electronic document having at least one electronic document identifier, section, rowtype and column extracted from the big data; a virtual memory for storing the relevant electronic document; a electronic form to capture data entry by at least one user based on set of instructions and pre-defined data field in at least one electronic dictionary; and a web-read module for retrieving the electronic document from the virtual memory using at least one identifier of electronic document based on the data of electronic form, wherein the electronic document append into at least one electronic file in the RDBMS according to a predefined page limit by a paging module and at least one account number defined by the user in the electronic form.

Further, the system comprising a enquiry module for retrieving a pluralities of electronic document information based on at least one information for the electronic document identifier, section, rowtype and column of electronic document, in which the retrieved electronic document information having at least one file history display into at least one list form.

Preferably, the web-read module for retrieving the electronic document, further comprising; a index module having at least one index for the electronic file based-on document identifier, date, end sequence number, document status, document offset and document length; and a read module to obtain the index and at least one data relative page of the electronic file from the index module based on the identifier, in which the electronic document retrieved from the paging module based on the retrieved index and data relative page to be stored in the virtual memory and update the index module.

Preferably, the identifier of electronic document comprising the electronic document identifier, section, rowtype and column.

The system according to claim 2, wherein the identifier of electronic document comprising document identifier, date, end sequence number, document status, document offset and document length.

Preferably, the data can be an unstructured data or structure data.

Preferably, the electronic file to be adhered to sarbanes-oxley (SOX) compliance, where the data stored in the electronic document is balanced.

Preferably, the electronic file encapsulates a plurality of electronic document based on the predefined page limit.

The system according to claim 1, further includes a data extraction module used for extracting data from electronic document by receiving instruction from a program and to retrieve a list of account using the retrieval module.

Preferably, the data extraction module populates the extracted data into at least one output table.

Further, the system comprising; a enquiry module for retrieving a pluralities of electronic document information based on at least one information for the electronic document identifier, section, rowtype and column of electronic document, in which the retrieved electronic document information having at least one file history display into at least one list form.

Preferably, the list form having at least one pre-defined information for each document.

Preferably, the enquiry module, further comprising a editing module to load the retrieved electronic document for updating the retrieved electronic document and store at least one updated data to the virtual memory.

Preferably, the enquiry module, further comprising a viewing module to load the retrieved electronic document for viewing the retrieved electronic document.

Preferably, the enquiry module further includes a searching module, wherein the searching module retrieves the electronic document using the web-read module based on at least one index, in which the index is retrieved from the identifier of electronic document comprising document identifier, date, end sequence number, document status, document offset and document length.

Preferably, the web-read module further includes a uploading module to upload the electronic document based the identifier of electronic document, in which the uploading module establish connection to at least one server having RDBMS and update the RDBMS with the uploaded electronic document.

A further aspect of present invention provides a method for storing and processing a big data dataset that operates on relational database management system (RDBMS), comprising steps of; capture data entry by at least one user based on set of instructions and pre-defined data field in at least one electronic dictionary using a electronic form; retrieving a electronic document from a virtual memory using at least one identifier of electronic document based on the data of electronic form, where the electronic document has at least one electronic document identifier, section, rowtype and column extracted from the big data; and appending the electronic document into at least one electronic file in the RDBMS according to a predefined page limit by a paging module and at least one account number defined by the user in the electronic form.

Further, the method includes Storage Processing Module, comprising steps of; obtaining at least one index and at least one data relative page of the electronic file having document identifier, date, end sequence number, document status, document offset and document length from a index module based on the identifier; retrieving the electronic document from the paging module based on the index and data relative page in the RDBMS; storing the electronic document in the virtual memory; and updating the index module.

Further, the method includes transaction processing system, comprising steps of; receiving the electronic document based on the data of electronic form; store received electronic document into transaction electronic file using paging and indexing module; update received electronic document to transaction electronic ledger using paging and indexing module; store received electronic document into master electronic file using paging and indexing module; update received electronic document to master electronic ledger using mapping module; and returning the update status to a output.

Further, the method includes parallel processing module, comprising steps of; receiving instruction either to create a plurality of databases and ledger identifier to be processed based the data of electronic form; creating databases based on the input instruction; distributing the electronic document from the defined ledger to databases created based last 2 or last 3 digit(s) of account number is used to determine which database the eDoc to be distributed using paging and index module; initiate parallel processing once all the electronic document have been distributed into the designated databases; and updating the processed result to the predefined control the electronic ledger through the mapping module.

Further, the method includes data extraction module, comprising steps of; receiving instruction based on the data of electronic form; retrieve a list of account using the retrieval module; retrieve a specific electronic document that belongs to an account using the retrieval module; extract any related fields from electronic document based on the instruction; and populate the extracted data into output table.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF PREFERRED EMBODIMENT

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

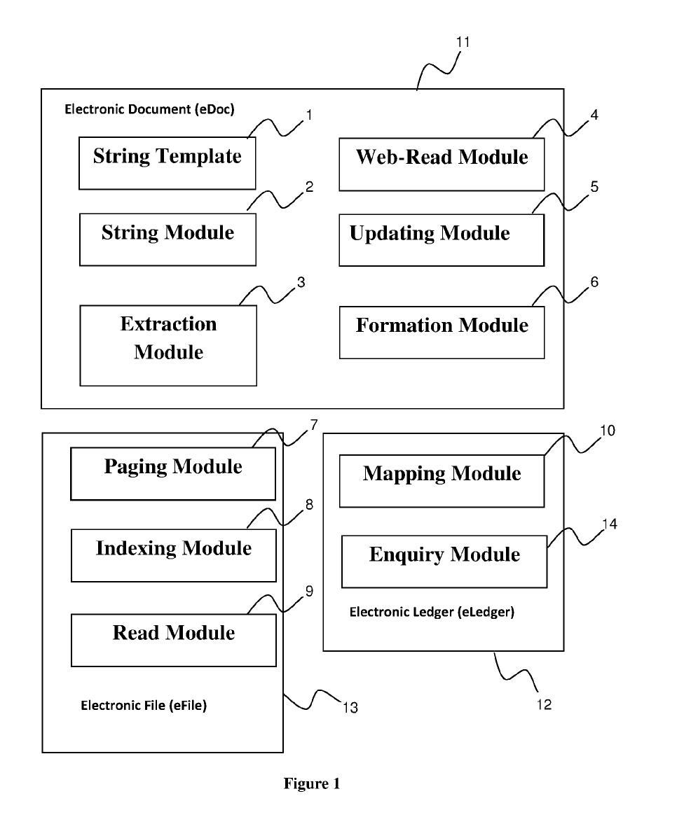

FIG. 1 illustrates overall architecture of the Electronic Document (eDoc) and Electronic File (eFile).

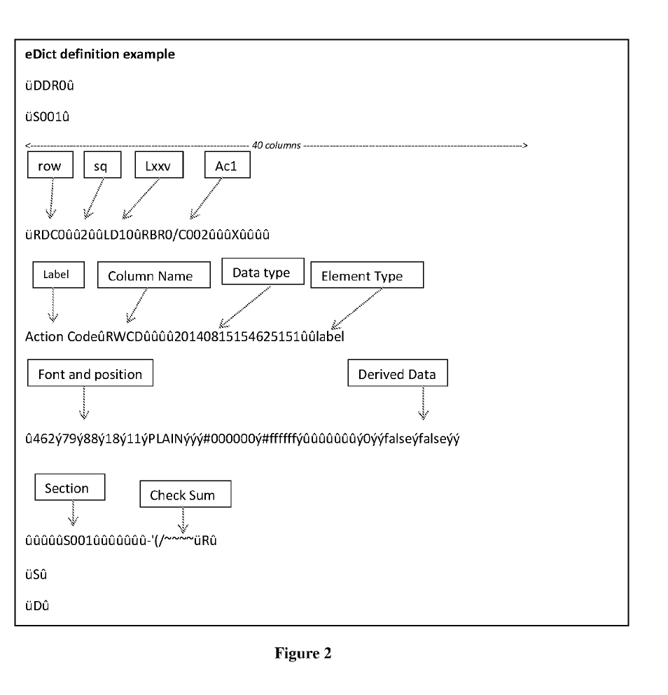

FIG. 2 illustrates an example of Electronic Dictionary (eDict) or metadata is used to describe the attribute/behavior in a string.

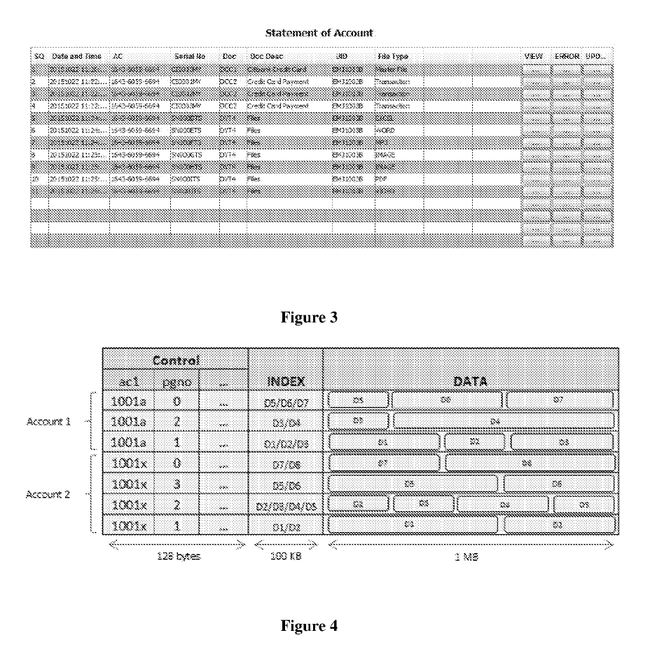

FIG. 3 illustrates an example of Statement of Account contains structure and unstructured data of an account.

FIG. 4 illustrates an example of how eFiles store in a RDBMS Table.

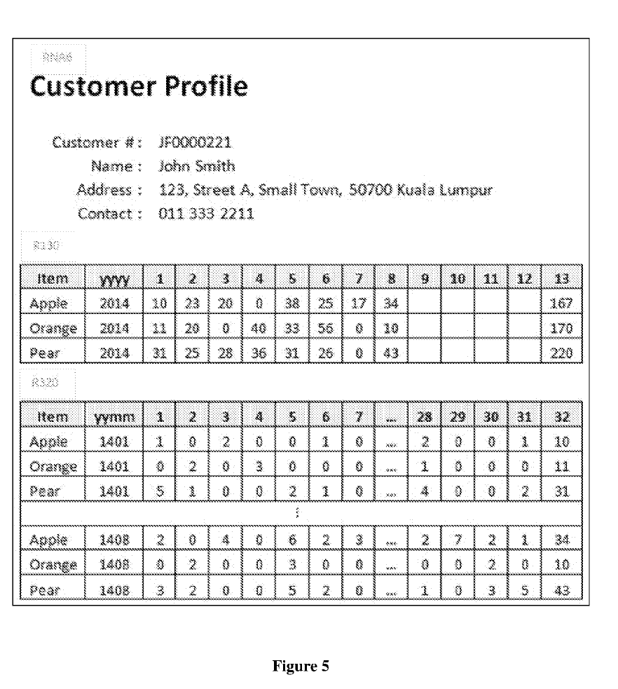

FIG. 5 illustrates an example eLedger containing details of a customer profile and item details.

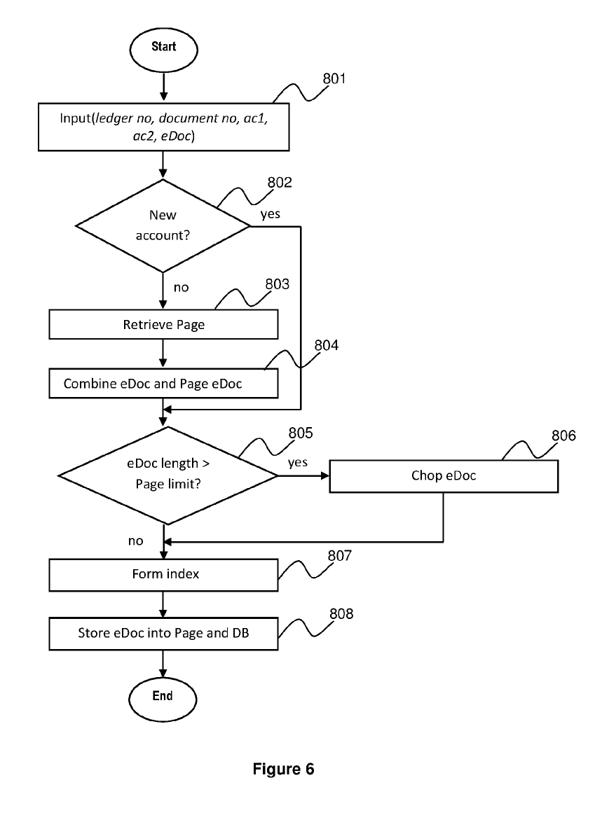

FIG. 6 illustrates a flow chart of a Storage Processing Module for storing transaction (eDoc) into database using the Paging Module.

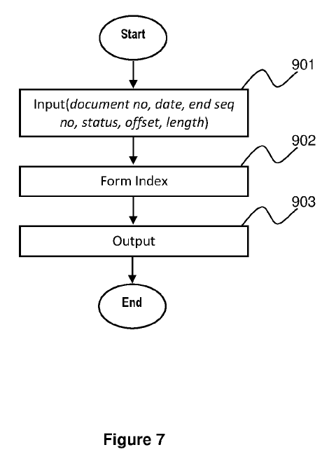

FIG. 7 illustrates a flow chart of a Storage Processing Module for storing transaction (eDoc) into database using the Index Module.

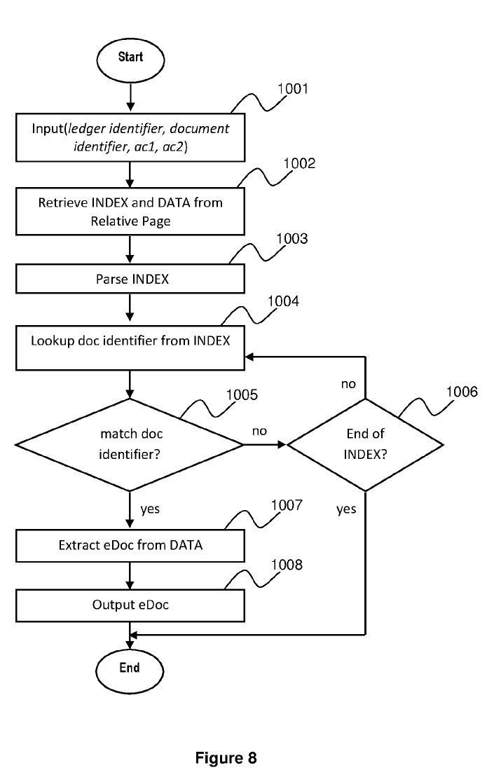

FIG. 8 illustrates a flow chart of a Storage Processing Module for storing transaction (eDoc) into database using the Reading Module.

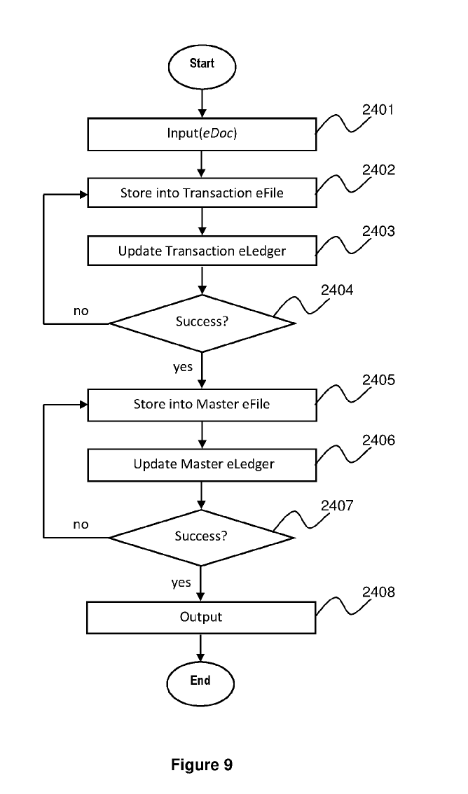

FIG. 9 illustrates a flow chart of a Transaction Processing Module.

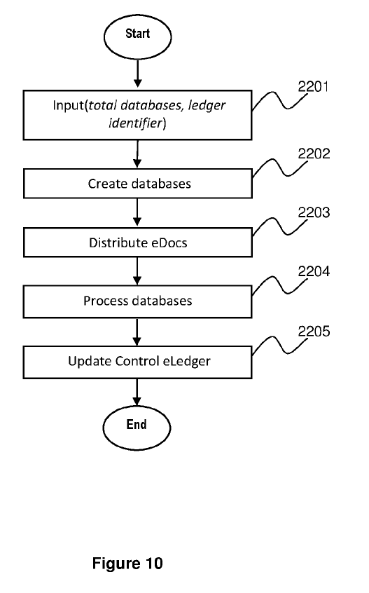

FIG. 10 illustrates a flow chart of a Parallel Processing Module.

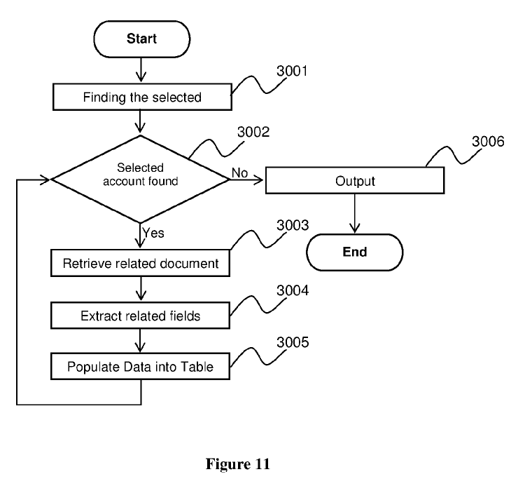

FIG. 11 illustrates a flow chart of a Data Extraction Module.

### DETAILED DESCRIPTION OF THE PREFERRED EMBODIMENTS

The proposed invention relates to a system and method for analyzing a Big Data dataset to emulate manual filing system by storing and processing document that operates on relational database. In particularly, using electronic document (eDoc) and electronic file (eFile) based system that operates on relational database.

Data for the big data is extracted, processed and stored in a format called Electronic Document (eDoc), which serves as the display, storage, processing, and transmission format throughout the systems development life cycle, without transformation at any stage. Data can be imported from or exported to any format including PDF, XML, XLS and CSV. Data can also be structure or unstructured and it is stored as a eDoc regardless size. Data is validated and stored in the predefined field in the eDoc.

The term “big data” relates to a collection of large and complex data sets (e.g., collection of data) that cannot be processed using existing hands-on database management tools within a practical time frame. Big data sizes is ranging from a few dozen terabytes to many petabytes of data in a single dataset. Big data consist of high volume, high velocity, and/or high variety information assets that involve advanced forms of processing to enable efficient decision making, insight discovery and process optimization. Big data also include structured datasets and unstructured datasets. An example of big data includes analysis of data sets can find new correlations, to “spot business trends, prevent diseases, combat crime and so on.

Big data can be described by the following characteristics:

Volume

Relates to quantity of generated data is important in this context, where the size of the data determines the value and potential of the data under consideration, and whether it can actually be considered big data or not.

Variety

Relates to type of content, and an essential fact that data analysts that can be recognized, where it assists people who are associated with and analyze the data to effectively use the data to their advantage and thus uphold its importance.

Velocity

Relates to the speed at which the data is generated and processed to meet the demands and the obstacle that lie in the path of growth and development.

Variability

Relates to inconsistency of the data displayed which can slow down the process of handling and managing the data effectively.

Veracity

Relates to the quality of captured data, which may differ significantly, therefore the accuracy of analysis depends on the veracity of source data.

Complexity

Relates to the very complex data management, especially when large volumes of data extracted from multiple sources. The extracted data must be linked, connected, and correlated so that the users able to capture the information on the data that supposed to be expressed.

An Electronic File (eFile) stores eDocs (with all data file types) on a relational database. Filing System predominantly utilizes the database read, write and index functions only. Therefore it can utilise almost all popular relational database, and if necessary can handle any customised, in-house database systems.

As illustrated in FIG. 1, the system to emulate manual filing system for storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); and a Extraction Module (3) for extracting the Electronic Document Identifier (eDoc-Identifier), Section, Rowtype and Column of Electronic Document (eDoc) (11) generated by the String Module (2) for retrieval process. The system also includes a Retrieval Module (4) for retrieving at least one Retrieved Data from the data of Electronic Document (eDoc) (11) stored in the database based on at least one Input of the Section, Rowtype and Column; a Updating Module (5) for updating the Retrieved Data of Electronic Document (eDoc) (11) and store at least one Updated Data to the database based on the Input of Section, Rowtype and Column defined; and a Formation Module (6) for forming the updated Electronic Document (eDoc) (11) by retrieving the Updated Data based on the Input of Section, Rowtype and Column. Further, the system has a Paging Module (7) for append Electronic Document (eDoc) (11) in the database into at least one Electronic File (eFile) (13) according to a predefined Page limit; a Indexing Module (8) for forming at least one Index to the Electronic File (eFile) (13) based-on document identifier, date, end sequence number, document status, document offset and document length; and a Read Module (9) for retrieving the Index and at least one Data Relative Page (Page 0) of the Electronic File (eFile) (13) based on at least one Read Input to at least one Output. In addition the system further includes a Mapping Module (10) for updating at least one Retrieved Data based on at least one Mapping Input by determining the Electronic File (eFile) (13) using the Read Module (9) to retrieve the Retrieved Data of Electronic Document (eDoc) (11) using the Retrieval Module (4), in which the Updating Module (5) update the Retrieved Data to the database and forming the Retrieved Data into the Electronic Document (eDoc) (11) using the Formation Module (6) for updating into at least one Electronic File (eFile) (13) using Paging Module (7) and forming at least one Index using the Indexing Module (8); and a Enquiry Module (14) for retrieving a pluralities of Electronic Document (eDoc) (11) information using a Mapping Module (10) based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

eDoc Filing System account-centric system that acts as a display, transmission, storage and processing medium from end to end without requiring any other transformation or normalization.

Electronic File (eFile) is an electronic folio (similar to a file in conventional manual filing systems) where all types of documents with different data types can be stored together in an account-centric manner.

The Filing system logically stores all data and information that relate to a single account in an Electronic File (eFile), in chronological order. Furthermore, no data is ever deleted from the eFile to be adhered to Sarbanes-Oxley (SOX) Compliance and the data is always balanced. The Account-centric eFile technology has reduced the RDBMS vertical stack size tremendously which also improved data retrieval speed. Instead of creating a new row for each record in RDBMS, the Account-centric eFile technology encapsulates any many eDocs as possible (depending of the Page size setting) before storing as a new record in RDBMS. For instance, data streaming in real-time from social media, Radio Frequency Identification (RFID) and so forth are feed directly into eFile before storing in RDBMS. The Electronic Document (eDoc) are stored as sequential strings of data mapped to a data dictionary, and may include multiple data types in each string (e.g. image files, binary files, comma separated format, XML or any of the nearly 500 data formats in existence today). This allows the storage of any type of data within one record. The way eDoc stores its data provides near real-time data mining without the need for data modeling.

eDoc is a data storage format comprising strings containing multiple rows each preceded by a unique row code: RxxV-Rxx being the row# and V the version#. Multiple rows of data of various rows make an eDoc. All data is stored in variable length or fixed length columns. Each row contains multiple columns separated by terminators. There are special terminators for start and end of DxxV (documents), RxxV (rows), etc. eDoc is designed for change. Various versions of RxxV and DxxV can exist concurrently. eDoc can be converted to XML and vice versa. eDoc is similar to XML as its data also has separators and identifiers and tags, but eDoc has additional system fields that provide new functionality. If required, XML is used as a universal transmission document and passed to other systems, where data can be normalized to tables. The table 1.0 and 2.0 further describes the terminators (separator) and identifiers and tags.

eDoc String

Example of eDoc String-Data Structure: (Store in LxxV)

```
üDxxVû
      üSxxVû
            üRID0ûûûûûûûûûûûûûûûûûûûûûûûüRû
            üRxxVûûû ... ûûûüRû
            ...
            üRxxVûûû ... ûûûüRû
      üSû
      ...
      üSxxVû
      ...
      üSû
üDû
```

Terminators (Separator) Coding Structure

TABLE 1.0
Basic Separator

| Code | Separator | Example |
|---|---|---|
| üDxxVû | Start Document | üDJS4û- start of Job sheet |
| üDû | End Document | üDû |
| üSxxVû | Start Section | üS001û- start of 1^{st} Section |
| üSû | End Section | üSû |
| üRxxVû | Start Row | üRNA1û- start of Name/Address Row |
| | | v1 |
| üRû | End Row | üRû |
| û | Field Separator | ûfield-1û . . . ûield-n |
| ý | SubField Separator | ý sub field-1 ý . . . ý subfield-n |
| ü[ | Open Packet | ü[üDJS1 . . . open packet for subDoc of |
| | | DJS1 |
| ü] | Close Packet | . . . üSûüDûü]close packet for the |
| | | subDoc |

LDSRC Coding Structure

TABLE 2.0

| Code | Description | Example |
|---|---|---|
| LxxV | Ledger Code | LJS4: Jobsheet Ledger version 4 |
| DxxV | Document Code | DJS4: Jobsheet Document version 4 |
| SxxV | Section Code | S001: Section 1 |
| RxxV | Row Code | RNA5: Name Address Rowtype version 5 |
| CxxV | Column Code | C005: Column 5 |
| VxxV | SubColumn Code | |

The Document Identifier (such as RID0) will only contain one or the whole Document, in which the Document Identifier is stored in the first Section. The Document Identifier contains details such as creator details, document details, update history, attributes and etc. Furthermore, the eDoc String data structure is also an Nth-dimension data structure where another eDoc String can be encapsulated within the ü[ . . . ü] and stored in a Column. The LDSRC Codes is also representing the GIS of an eDoc String stored. To retrieve the eDoc String, the LDSRC Codes are used to locate them. Therefore, the coding structures are intelligent.

eDict

As illustrated in FIG. 2, the Electronic Dictionary (eDict) or metadata is used to describe the attribute/behavior of each ledger (LxxV), document (DxxV) and Rowtype (RxxV). For LxxV level, the ledger identifier, eDoc updating methods (FIFO, LIFO, Update or Overwrite) and number of eDoc to be kept in eLedger is predefined in Ledger type eDict. For DxxV level, the document type to be or can be stored is predefined in the Document type eDict. For RxxV level, the Rowtype type eDict is categorized into 3 parts; first, general attributes such as name, data type, data length and so forth; second, display attributes such as font type, size, color and so forth; third, computation attributes like data validation and computation.

As illustrated in FIG. 3, Statement of Account contains list of examples of structure and unstructured data of an account. From the list, data from data entry form like master file and transaction file are structure data and data from images, text and output file from other programs are unstructured data. The list also shows a complete history of all eDocs of an account and it is useful during auditing.

eLedger

Electronic Ledger (eLedger) is where summaries or derivatives of eFile that is kept in variable length format thus allowing for greater flexibility and fast retrieval. Each eFile can have multiple eLedgers if required (for speedy reporting purposes). The update method of each eFile to the eLedger is predefined in eLedger dictionary. The update approach for each eLedger is incremental based; the last processed eDoc sequence number in eFile is the starting point of the next update processing. This is to avoid the reprocessing of all eDocs in eFile being repeated on every update. The updating process can be triggered in scheduled or in real-time manners. In the Big Data perspective, eLedger for single account, a group of accounts or all accounts can be built for analytic and predictive purposes. For instance, a eLedger can be built to demonstrate a customer's spending pattern and the pattern can be used to predict the customer's future spending pattern as well. The system may further include Zero Balancing function where every transaction can be traced and no information is ever deleted, which means everything will be balanced (always balance to last cent). All transactions have a copy in the Transaction Ledger, so changes to any account are immediately verifiable and problems isolated. The system also may make the system naturally SOX Compliant (Sarbanes-Oxley Act of 2002). The system may further include Reverse Processing where a new eLedger can be generated or regenerated from eFile based on new configuration or updated configuration.

As illustrated in FIG. 4, the eLedger contains example customer profile that includes customer details (RNA6—Name and Address Rowtype) and summary of total item such as apple, orange and pear bought daily (R320—32-day Rowtype) and monthly (R130—13-month Rowtype) for year 2014. The summary in the eLedger are populated from the daily transactions in eFile.

Header+Index+Data

As illustrated in FIG. 5, the eFiles are stored in a RDBMS table, where the table comprises of Control, Index and Data. The Control section contains key and details about the Page. The Index is used to locate the location of each eDoc in a Page. The Data is where the eFile is stored.

Example of Index for Account 1, Relative Page is as below:

DHR0:20140828: 5: U: 0: 122/DHR0:20140828: 6: U: 122:
250/DHR0:20140828: 7: U: 250: 372/

Each account contains a eFile and the eFile contains number of eDocs. The eFile is chopped into Pages according to Page size before storing into RDBMS. The Page number begins from Relative Page and when a new Page is added, the Relative Page is advanced to Page 1 and the Page number of the newly added Page is 0 and so forth. Besides that, Relative Page is also a relative page to the system; the enquiry will always start from Relative Page.

The Control section may also include the following:
lg—ledger identifier
ac1—account 2
lpgn—last page no
ssq—start document sequence no
sln—start Page line no
esq—end document sequence no
eln—end Page line no
date—last updated date
st—the status of the eFile such as deleted
co—company and department
bal—balance of all eDocs

As illustrated in FIG. 6, the storage processing system will receiving ledger identifier, document identifier, account 1 and account 2 and eDoc from a program (801). Then, validate with the database if this account is a new account (802). If it's not a new account, retrieve the existing Page from the database for later processing (803). Then, append eDoc form input to the eDoc from Page (804). However, if it's a new account, the system further validate if the length of the combined eDoc is greater than the Page limit (805). If the length of the combined eDoc is greater than Page Limit, chop the combined eDoc into x Pages according to Page limit (806). On the other hand, if the length of the combined eDoc is not greater than Page Limit, each Page Index will be formed base-on document identifier, date, end sequence no, document status, document offset and document length (807). Finally, storing Page and Index into database (808).

As illustrated in FIG. 7, the Storage Processing system used for Indexing will receive document identifier, date, end sequence no, 5 document status, document offset and document length from a program (901). Then, form Index by combining all input as a string and each input is separated by colon (:) (902). Finally, the system returns the formed Index to the program that triggered this operation (903).

As illustrated in FIG. 8, the Storage Processing system used for Reading eDoc from database will receive ledger identifier, document identifier, account 1 and account 2 from a program (1001). Then, retrieve INDEX (indexes) and DATA of Relative Page for a given account from a eFile from the database (1002). Then, parse INDEX into individual index (1003). Thereafter, lookup index that contains document identifier from the input received (1004). The, verify if there is any document identifier is found (1005). if document identifier is not found, validate if there are more indexes (1006). If there are more indexes, lookup index and further verify if there is any document identifier is found. However, if document identifier is found, from the index found, retrieve the offset and the length of the target eDoc. Then extract the eDoc from DATA (1007). Finally, the system output eDoc found (1008).

As illustrated in FIG. 9, the Transaction Processing System used for Processing eDoc Transaction by receiving eDoc from a program (2401). Then, store received eDoc into Transaction eFile using Paging and Indexing Module (2402). Thereafter, update received eDoc to Transaction eLedger using Paging and Indexing Module (2403). Verify if Transaction eLedger updated successfully (2404). If received eDoc updated successfully, the system will store received eDoc into Master eFile using Paging and Indexing Module (2405). Then, update received eDoc to Master eLedger using Mapping Module (2406). Verify if Master eLedger updated successfully (2407). Then, if Master eLedger updated successfully, the system returning the update status (2408).

As illustrated in FIG. 10, Parallel Processing System used for Parallel Processing of documents where the system receiving instruction either to create 10, 100 or 1000 databases and ledger identifier to be processed from a program (2201). Then, create databases based on the input instruction (2202). Thereafter, distribute eDocs from the defined ledger to databases created using Paging and Index Module. The last, last 2 or last 3 digit(s) of account number is used to determine which database the eDoc to be distributed to (2203). Then, start parallel processing once all eDocs have been distributed into the designated databases (2204). Finally, the system will update the processed result to the predefined Control eLedger through the Mapping Module (2205).

As illustrated in FIG. 11, the Data Extraction Module used for extracting data from eDocs by receiving instruction from a program and to retrieve a list of account using the Retrieval Module (3001). Verify if the list contains any unprocessed account (3002). If there is unprocessed account, retrieve eDoc using the Retrieval Module (3003). Then, extract fields (3004). After that, populate the extracted data into output table (3005). Finally, the system will return the table as result to the program that trigged this operation. If there is no unprocessed account the system will return to output as not results found (3006).

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1.-21. (canceled)

22. A system for storing and processing a big data dataset that operates on a relational database management system (RDBMS), comprising:
an electronic document having at least one electronic document identifier, section, rowtype and column extracted from the big data;
a virtual memory for storing the electronic document;
an electronic form to capture data entry by at least one user based on a set of instructions and pre-defined data fields in at least one electronic dictionary; and
a web-read module for retrieving the electronic document from the virtual memory using at least one identifier of the electronic document based on the data of the electronic form, wherein the electronic document appends into at least one electronic file in the RDBMS according to a predefined page limit by a paging module and at least one account number defined by the user in the electronic form.

23. The system according to claim 22, further comprising:
an enquiry module for retrieving a plurality of electronic document information based on at least one information for the electronic document identifier, section, rowtype and column of the electronic document, in which the retrieved electronic document information has at least one file history displayed into at least one list form.

24. The system according to claim 22, wherein the web-read module for retrieving the electronic document further comprises:
an index module having at least one index for the electronic file based-on document identifier, date, end sequence number, document status, document offset and document length; and
a read module to obtain the index and at least one data relative page of the electronic file from the index module based on the identifier, in which the electronic document retrieved from the paging module based on the retrieved index and data relative page to be stored in the virtual memory and update the index module.

25. The system according to claim 22, wherein the identifier of the electronic document comprises the electronic document identifier, section, rowtype and column.

26. The system according to claim 23, wherein the identifier of the electronic document comprises the document identifier, date, end sequence number, document status, document offset and document length.

27. The system according to claim 22, wherein the data is unstructured data or structure data.

28. The system according to claim 22, wherein the electronic file adheres to Sarbanes-Oxley (SOX) compliance, where the data stored in the electronic document (11) is balanced.

29. The system according to claim 22, wherein the electronic file encapsulates a plurality of electronic documents based on the predefined page limit.

30. The system according to claim 22, further comprising:
a data extraction module used for extracting data from the electronic document by receiving instructions from a program and retrieving a list of accounts using a retrieval module.

31. The system according to claim 22, wherein the data extraction module populates the extracted data into at least one output table.

32. The system according to claim 22, further comprising:
an enquiry module for retrieving a plurality of electronic document information based on at least one information for the electronic document identifier, section, rowtype and column of electronic document, in which the retrieved electronic document information has at least one file history displayed into at least one list form.

33. The system according to claim 32, wherein the list form has at least one pre-defined information for each document.

34. The system according to claim 32, wherein the enquiry module further comprises:
an editing module to load the retrieved electronic document for updating the retrieved electronic document and store at least one updated data to the virtual memory.

35. The system according to claim 32, wherein the enquiry module further comprises:
a viewing module to load the retrieved electronic document for viewing the retrieved electronic document.

36. The system according to claim 32, wherein the enquiry module further comprises:
a searching module, wherein the searching module retrieves the electronic document using the web-read module based on at least one index, in which the index is retrieved from the identifier of electronic document comprising document identifier, date, end sequence number, document status, document offset and document length.

37. The system according to claim 22, wherein the web-read module further comprises:
an uploading module to upload the electronic document based the identifier of electronic document, in which the uploading module establishes a connection to at least one server having RDBMS and updates the RDBMS with the uploaded electronic document.

38. A method for storing and processing a big data dataset that operates on relational database management system (RDBMS), comprising the steps of:
capturing data entry by at least one user based on a set of instructions and pre-defined data fields in at least one electronic dictionary using an electronic form;
retrieving an electronic document from a virtual memory using at least one identifier of electronic document based on the data of the electronic form, where the electronic document has at least one electronic document identifier, section, rowtype and column extracted from the big data; and
appending the electronic document into at least one electronic file in the RDBMS according to a predefined page limit by a paging module and at least one account number defined by the user in the electronic form.

39. The method according to claim 38, further comprising the steps of:
obtaining at least one index and at least one data relative page of the electronic file having document identifier, date, end sequence number, document status, document offset and document length from an index module based on the identifier;
retrieving the electronic document from the paging module based on the index and data relative page in the RDBMS;
storing the electronic document in the virtual memory; and
updating the index module.

40. The method according to claim 38, further comprising the steps of:
receiving the electronic document based on the data of electronic form;
storing the received electronic document into a transaction electronic file using a paging and indexing module;
updating the received electronic document to a transaction electronic ledger using the paging and indexing module;
storing the received electronic document into a master electronic file using the paging and indexing module;
updating the received electronic document to a master electronic ledger using a mapping module; and
returning the update status to an output.

41. The method according to claim 38, further comprising the steps of:
receiving an instruction either to create a plurality of databases and ledger identifiers to be processed based on the data of the electronic form;
creating databases based on the input instruction;
distributing the electronic document from the defined ledger to databases created based on the last 2 or 3 digits of the account number is used to determine which database an eDoc to be distributed using a paging and index module;
initiating parallel processing once all of the electronic documents have been distributed into the designated databases; and
updating the processed result to a predefined control of the electronic ledger through the mapping module.

42. The method according to claim 38, further comprising the steps of:
receiving an instruction based on the data of the electronic form;
retrieving a list of accounts using a retrieval module;
retrieving a specific electronic document that belongs to an account using the retrieval module;
extracting any related fields from the electronic document based on the instruction;
populating the extracted data into an output table.
